(19) United States
(12) Patent Application Publication
(10) Pub. No.: US 2015/0266370 A1
(43) Pub. Date: Sep. 24, 2015

(54) COOLING CIRCUIT FOR A MOTOR VEHICLE AND USE OF AN ELECTRICALLY NON-CONDUCTIVE COOLING FLUID

(71) Applicant: Dr. Ing. h.c.F. Porsche Aktiengesellschaft, Stuttgart (DE)

(72) Inventor: Michael Fuerstner, Gerlingen (DE)

(21) Appl. No.: 14/658,491

(22) Filed: Mar. 16, 2015

(30) Foreign Application Priority Data
Mar. 21, 2014 (DE) 10 2014 103 909.2

(51) Int. Cl. B60K 11/02

(52) U.S. Cl. CPC B60K 11/02

(57) ABSTRACT

A cooling circuit for a motor vehicle has an engine cooling portion (16) for cooling a motor vehicle engine, a battery cooling portion (14) for cooling a motor vehicle battery, and a cooling fluid flowing through both the engine cooling portion (16) and the battery cooling portion (14). The cooling fluid is electrically non-conductive and is in direct contact with electrical contact surfaces of the motor vehicle battery.

### CROSS REFERENCE TO RELATED APPLICATION

This application claims priority under 35 USC 119 to German Patent Appl. No. 10 2014 103 909.2 filed on Mar. 21, 2014, the entire disclosure of which is incorporated herein by reference.

### BACKGROUND

1. Field of the Invention

The invention relates to a cooling circuit for a motor vehicle and to a method of using an electrically non-conductive cooling fluid to cool a motor vehicle engine of a motor vehicle.

2. Description of the Related Art

WO 95/07323 A1 discloses a substantially waterless synthetic cooling fluid that can be used for cooling a motor vehicle engine. The cooling fluid has a proportion of water of below 0.5% by weight, and therefore allows little corrosion of the metallic components in a cooling circuit.

There is a constant need for the cooling requirement of a motor vehicle to be covered with as little outlay on apparatus as possible. Therefore, an object of the invention to meet the cooling requirement of a motor vehicle with little outlay on apparatus.

### SUMMARY OF THE INVENTION

The invention relates to a cooling circuit for a motor vehicle with an engine cooling portion for cooling a motor vehicle engine, a battery cooling portion for cooling a motor vehicle battery, and a cooling fluid flowing through both the engine cooling portion and the battery cooling portion. The cooling fluid is electrically non-conductive. As a result, the cooling circuit enables the cooling fluid to flow in direct contact with electrical contact surfaces of the motor vehicle battery without risk of a short circuit. Accordingly, the electrical contacts are flushed directly with the cooling fluid, and a particularly high heat transfer capacity between the motor vehicle battery and the cooling fluid can be achieved. An interposed medium or an air gap between the electrical contacts of the motor vehicle battery and the cooling fluid can be avoided, and therefore a correspondingly high cooling capacity can be achieved. In addition, the cooling of the motor vehicle battery and the cooling of the motor vehicle engine can be achieved by a common cooling circuit. As a result, it is possible to provide just one single common cooling circuit for cooling both the motor vehicle engine and the motor vehicle battery, thereby reducing the outlay on apparatus for cooling the motor vehicle engine and the motor vehicle battery. In comparison to two separate cooling circuits for the motor vehicle engine and the motor vehicle battery, it is possible to use, for example, a common feed pump and/or a common heat exchanger and/or a common condenser or the like. Therefore the number of apparatus components can be reduced. The use of the cooling fluid for cooling the motor vehicle engine and for directly cooling the electrical contacts of the motor vehicle battery in a common cooling circuit results in a small outlay for apparatus to meet the cooling requirement of a motor vehicle.

The engine cooling portion can have cooling lines that are routed through the motor vehicle engine. For example, the engine cooling portion can have a cooling jacket that at least partially surrounds combustion cylinders of the motor vehicle engine and through which the cooling fluid can flow to remove a portion of the heat arising in the combustion cylinder during combustion. The battery cooling portion can have a covering connected to the motor vehicle battery and therefore the cooling fluid can flow between the covering and the motor vehicle battery along that surface of the motor vehicle battery that is covered by the covering and, in the process, can also flow directly around the electrical contact surfaces of the poles of individual battery cells. The engine cooling portion and the battery cooling portion can be connected to each other via a connecting line for the passage of the cooling fluid. The cooling circuit may be provided with a single feed pump, for conveying the cooling fluid. The cooling circuit can have a condenser for liquefying gaseous cooling fluid if the cooling fluid is intended to have a phase change (i.e. evaporation) to provide a correspondingly high cooling capacity. A suitable cooling fluid is described, for example, in WO 95/07323 A1, the contents of which are incorporated herein by reference.

The engine cooling portion and the battery cooling portion may be connected in series in the direction of flow of the cooling fluid. As a result, the cooling fluid can flow successively through the engine cooling portion and the battery cooling portion. Thus, a branching of the mass flow of the cooling fluid into two parallel flow portions is avoided. As a result, the entire mass flow of the cooling fluid, and therefore the entire heat capacity of the cooling fluid, is available for cooling the motor vehicle engine and the motor vehicle battery. A correspondingly higher amount of heat is required for heating the cooling fluid to a higher temperature. The motor vehicle battery of a hybrid vehicle is a traction battery for purely electrical driving of the motor vehicle. Use is made here of the finding that, in most operating states, driving is undertaken either only purely electrically or only purely by the engine. Therefore additional heat that is to be removed generally arises either only at the motor vehicle engine or only at the motor vehicle battery. Excessive heating of the cooling fluid should therefore not be anticipated.

A heat exchanger for cooling the cooling fluid may be provided either between the engine cooling portion and the battery cooling portion or between the battery cooling portion and the engine cooling portion in the direction of flow of the cooling fluid. As a result, the cooling device that can compensate for heating the cooling fluid during the cooling of the motor vehicle engine and of the motor vehicle battery is provided only at one location in the cooling circuit. The outlay on apparatus for forming the cooling circuit is thereby particularly low. The cooling device is formed by a front radiator of the motor vehicle around which air flows.

A waterless cooling fluid with a water content of 0.5% by weight may be provided as the cooling fluid. Little corrosion of the metallic components in a cooling circuit is allowed because of the low water content. For example, corrosion of a heat exchanger and/or corrosion of the electrical contact surfaces of the motor vehicle battery can be avoided or at least significantly reduced. Furthermore, a heat transfer resistance that increases due to corrosion can be avoided, and therefore a high cooling capacity can be maintained over the service life of the motor vehicle.

The cooling fluid may have an electrical conductivity σ of 0 S/m≦σ≦10−2 S/m, in particular 10−11 S/m≦σ≦10−4 S/m, preferably 10−10 S/m≦σ≦10−6 S/m and particularly preferably 10−9 S/m≦σ≦10−8 S/m. A suitable cooling fluid may be a mixture of 50% by weight of glycol and 50% by weight of demineralized water, in particular ultra pure water, with an electrical conductivity of approximately σ=3.25 10−3 S/m and/or the synthetic coolant “EVS-MBN-03” from Evans Cooling Systems UK with an electrical conductivity of approximately σ=5 10−4 S/m. At such an electrical conductivity, a significant short-circuit current does not occur between the electrical contact surfaces of the motor vehicle battery. Instead, the cooling fluid acts as insulator and/or dielectric between the electrical contact surfaces.

The motor vehicle battery may a traction battery for purely electrical driving of the motor vehicle. The traction battery may have a multiplicity of battery cells each having a pair of electrical contact surfaces around which the cooling fluid can flow. As noted above, it has been found that, in most operating states of a hybrid vehicle, driving is undertaken either only purely electrically or only purely by motor, and therefore additional heat that is to be removed generally arises either only at the motor vehicle engine or only at the motor vehicle battery. Thus, excessive heating of the cooling fluid should not be anticipated. In addition, the traction battery has a multiplicity of battery cells that readily can be cooled via the cooling of the electrical contact surfaces that project deeply into the battery cell and have a high co-efficient of heat conduction.

The invention also relates to a method of using an electrically non-conductive cooling fluid in the above described cooling circuit for cooling a motor vehicle engine and a motor vehicle battery. The method includes urging the cooling fluid into direct contact with electrical contact surfaces of the motor vehicle battery. A suitable cooling fluid is described, for example, in WO 95/07323 A1, the contents of which are incorporated herein by reference. Use of the cooling fluid both for cooling the motor vehicle engine and directly cooling electrical contacts of the motor vehicle battery in a common cooling circuit reduces the outlay on apparatus for the cooling requirement of a motor vehicle.

The invention is explained by way of example below using a preferred exemplary embodiment with reference to the attached drawing, wherein the features illustrated below, both in each case individually and in combination, can constitute an aspect of the invention.

### BRIEF DESCRIPTION OF THE DRAWINGS

FIG. 1 is a schematic basic illustration of a cooling circuit.

### DETAILED DESCRIPTION

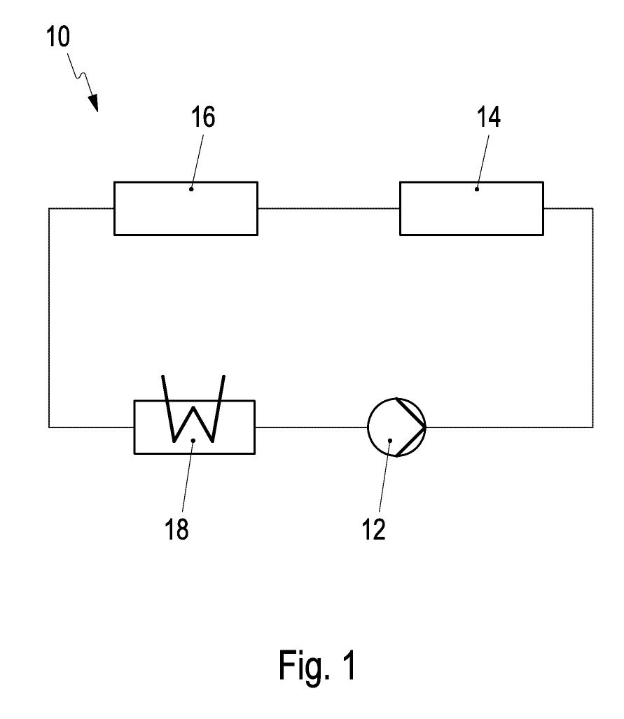

A cooling circuit 10 is illustrated in FIG. 1 and has a feed pump 12 that pumps an electrically non-conductive cooling fluid into a battery cooling portion 14 where the cooling fluid can flow around and cool electrical contacts of a motor vehicle battery, such as a traction battery for a hybrid vehicle. The cooling fluid then passes into an engine cooling portion 16 where the cooling fluid can absorb combustion heat in arising in combustion cylinders. The cooling fluid subsequently flows into a heat exchanger 18 that is formed by a front radiator and in which the cooling fluid is cooled down to the previous operating temperature thereof in the feed pump 12. Just one cooling circuit 10 with a single feed pump 12 and/or just a single heat exchanger 18, and a common coolant are required for cooling the motor vehicle battery and the motor vehicle engine.

What is claimed is:

1. A cooling circuit for a motor vehicle, comprising
an engine cooling portion for cooling a motor vehicle engine,
a battery cooling portion for cooling a motor vehicle battery, and
a cooling fluid flowing through both the engine cooling portion and the battery cooling portion,
wherein the cooling fluid is electrically non-conductive and is in direct contact with electrical contact surfaces of the motor vehicle battery.

2. The cooling circuit of claim 1, wherein the engine cooling portion and the battery cooling portion are connected in series in a direction of flow of the cooling fluid.

3. The cooling circuit of claim 2, further comprising at least one heat exchanger for cooling the cooling fluid, the heat exchanger being provided between the engine cooling portion and the battery cooling portion.

4. The cooling circuit of claim 1, wherein the cooling fluid has a water content of ≦0.5% by weight.

5. The cooling circuit of claim 1, wherein the cooling fluid has an electrical conductivity σ of 0 S/m≦σ≦10⁻² S/m.

6. The cooling circuit of claim 5, wherein the cooling fluid has an electrical conductivity σ of 10⁻¹¹ S/m≦σ≦10⁻⁴ S/m.

7. The cooling circuit of claim 6, wherein the cooling fluid has an electrical conductivity σ of 10⁻¹⁰ S/m≦σ≦10⁻⁶ S/m.

8. The cooling circuit of claim 7, wherein the cooling fluid has an electrical conductivity σ of 10⁻⁹ S/m≦σ≦10⁻⁸ S/m.

9. The cooling circuit of claim 1, wherein the motor vehicle battery is a traction battery for purely electrical driving of the motor vehicle, the traction battery having a multiplicity of battery cells each having two electrical contact surfaces around which the cooling fluid flows.

10. The cooling circuit of claim 1, further comprising a single feed pump.

11. The cooling circuit of claim 10, further comprising a single heat exchanger.

12. The cooling circuit of claim 11, wherein the single heat exchanger is between the engine cooling portion and the battery cooling portion.

13. A method for cooling a motor vehicle engine and for cooling a motor vehicle battery, comprising:
providing an electrically non-conductive cooling fluid; and
directing the cooling fluid into heat exchange relationship with the motor vehicle engine and into direct contact with electrical contact surfaces of the motor vehicle battery.

14. The method of claim 13, wherein the step of directing the cooling fluid into heat exchange relationship with the motor vehicle engine and into direct contact with electrical contact surfaces of the motor vehicle battery comprises directing the cooling fluid initially into heat exchange relationship with the motor vehicle engine and then into direct contact with the electrical contact surfaces of the motor vehicle battery.

15. The method of claim 13, wherein the step of directing the cooling fluid into heat exchange relationship with the motor vehicle engine and into direct contact with electrical contact surfaces of the motor vehicle battery comprises directing the cooling fluid initially into direct contact with the electrical contact surfaces of the motor vehicle battery and then into heat exchange relationship with the motor vehicle engine.
